(19) United States
(12) Patent Application Publication
(10) Pub. No.: US 2004/0250489 A1
(43) Pub. Date: Dec. 16, 2004

(54) Open cross section elongated member, and structural slab made with an horizontal array of said elongated members, a plurality of blocks of insulating material disposed between them, a net disposed above them and concrete that makes rigid the slab

(76) Inventor: Jose Rojas, Santiago (CL)

Correspondence Address: FULBRIGHT & JAWORSKI, LLP, 1301 MCKINNEY, SUITE 5100, HOUSTON, TX, 77010-3095, US

(21) Appl. No.: 10/819,599

(22) Filed: Apr. 7, 2004

(30) Foreign Application Priority Data
Apr. 8, 2003 (CL) 0719-2003

(51) Int. Cl. E06B 3/54

(52) U.S. Cl. 52/474; 52/415

(57) ABSTRACT

The invention correspond to a elongated member (1) made of metal, or another suitable material, with appropriate structural features for construction, and a structural slab (6) which uses said elongated members, which is able to more than satisfy the structural requirements and isolation requirements of the related project, and requires a significantly fewer number of auxiliary supporting elements during the construction, which involves low purchase costs of the different related components, transportation and installation in situ. The cross section of said elongated member (1) is hollow and opened on top and its outline is similar to an upside-down “T”. Said structural slab (6) is fabricated with a horizontal array of said elongated members (1), a plurality of blocks of isolating material (7) arranged between the same, a mesh (8) made of metal, or another suitable material, arranged on the same and a concrete element (9) working as a composed structural system in combination with the other elements of the structural slab (6).

### BACKGROUND OF THE INVENTION

The present invention is firstly related with a hollow open cross section elongated member made of metal, or another suitable material, which has appropriate structural features for the construction, and secondly with a structural slab which comprises an horizontal array made with a plurality of the above mentioned elongated members.

The construction of structural slabs is a highly required activity in the related industry. Said slabs must be able to satisfy properly the requirements of the related structural project, and to involve competitive costs.

Among the different slab systems that have been used, in order to satisfy the above mentioned requirements, there is one having a particularly good structural and isolating performance, being, at the same time, able to be fabricated relatively quick and involving adequate costs. Said slab system is made with an horizontal array of elongated members, a plurality of blocks made of acoustic and thermal isolating material, a metallic mesh arranged on said elongated members and a concrete element which works together with the rest of the components of the slab.

Said elongated members, of said horizontal array of elongated members, are equidistantly arranged respect to each other, and they are laid on the supports of the slab; besides, the cross section of said beams become bigger downwards. Said blocks of isolating material are preferably made of Expanded Polystyrene (EPS), or another suitable material, and are arranged between said beams, being supported by the lower wider part of the cross section of the same; besides, said blocks of isolating material satisfy firstly the acoustic and thermal requirements of the related project, and in the other hand said blocks of isolating material work as a mould for the concrete that is going to be poured over the top of the components of the slab. Said metallic mesh is very important in order to allow said structural slab (6) to work as a composed structural system. Said concrete element is fabricated starting from a predetermined amount of concrete which is poured over the other components of the slab and allow the different components of the slab to work as a composed structural system; said concrete element fills essentially all the places between an horizontal plane located a little over said metallic mesh and the upper surfaces of said elongated members, made of metal, and said blocks of isolating material.

The kind of beams that have been used in this slab system are prefabricated beams made of reinforced concrete, which are relatively light and economic, however, in the other hand they are relatively fragile, so they need special cares during the construction process in situ. Besides, said kind of beams require, during the concrete harden process, the installation of a big number of auxiliary supporting elements oriented to avoid the downward bending of the structural slab (6) caused by its own weight, which would deteriorate in a very important way the structural performance of said slab if said bending problem were not properly avoided during the concrete harden process.

Regarding the above exposed facts, it can be concluded that despite the fact that the slab system performance described above is good, said system has some problems that should be solved because of the high competitiveness in the related industry. This means that there is a necessity for creating new structural slab systems which may satisfy properly the structural requirements, isolating requirements and other requirements associated to the related project. Besides, said new structural slab system should require a fewer number of auxiliary supporting elements during the concrete harden process

### DESCRIPTION OF THE INVENTION

The present invention is firstly related with a hollow open cross section elongated member (1), made of metal or other suitable material, which has very convenient structural features that makes it suitable for the fabrication of slabs, and other structural elements; and secondly, with a structural slab (6) fabricated with a plurality of said elongated members (1), blocks of isolating material (7), a mesh (8) made of metal, or other suitable material, and a concrete element (9) which works as a composed structural system in combination with the other elements of the structural slab (6).

The elongated member (1) of the invention is hollow and its cross section is open in the top and is substantially symmetrical with respect to a symmetry vertical plane. Said cross section comprises a first couple of walls, essentially symmetrical with respect to said symmetry vertical plane, each one connecting an upper end (2) with a lower end (3), where said lower end (3) is essentially lower than said upper end (2) and farther from said symmetry vertical plane than said upper end (2); and a second couple of walls, essentially symmetrical with respect to said symmetry vertical plane, each one connecting one of said lower ends (3), of said first couple of walls, with said symmetry vertical plane in a joining point (4) where are joined said walls of said second couple of walls; in such a way that said cross section of said elongated member (1) defines a cavity, opened on its top, which is significantly wider in at least one zone of its lower part with respect to its upper part.

Additionally said cross section of said elongated member (1) may comprise a third couple of walls, essentially symmetrical with respect to said symmetry vertical plane, each one connecting one of said upper ends (2), of said first couple of walls, with a final end (5) which is essentially at the same height than said upper end (2) and farther from said symmetry vertical plane than said upper end (2).

Besides, each one of said walls of said third couple of walls may comprise a reinforcement fold, which reinforces the cross section of said elongated member (1) in the zone of said third couple of walls where said final ends (5) are located.

The structural slab (6) of the invention comprises a horizontal array of hollow elongated members (1), like the ones described above, separated respect to each other a distance essentially similar; a plurality of blocks of isolating material (7), whose density is essentially smaller than concrete, arranged between said elongated members (1) and supported by the side of the same, where the upper part of said blocks of isolating material (7) is arranged essentially lower than the upper part of said elongated members (1); a mesh (8) which is supported by the upper part of said horizontal array of elongated members (1); a concrete element (9) which fills essentially all the places between an horizontal plane located a little over said mesh (8) and the upper surfaces of said elongated members (1) and said blocks of isolating material (7).

Said elongated members (1) are laid on the supports of the structural slab (6); besides, said elongated members (1), together with the concrete poured inside and around the same, become the beams of the structural slab (6). Said blocks of isolating material (7) are preferably made of Expanded Polystyrene (EPS), or another suitable material, and are supported on the wider lower part of said elongated members (1); said blocks of isolating material (7) satisfy firstly the acoustic and thermal requirements of the related project, and in the other hand they work as a mould for the concrete that is going to be poured over the top of the components of the structural slab (6), in order to make said concrete element (9). Said mesh (8) is very important in order to allow said structural slab (6) to work as a composed structural system. Said concrete element (9) is fabricated starting from a predetermined amount of concrete which is poured over the other components of the structural slab (6) and allow the different components of said structural slab (6) to work as a composed structural system.

The elongated member (1) of the invention has big advantages, with respect to the ones that are currently being used in the art, when it is used for fabricating structural slabs (6), because of firstly said elongated member (1) involves a simple manufacturing process, it is light and impact resistant; and secondly, the geometry of the same gives a outstanding structural performance to the related structural slab (6) of the invention, in which said horizontal array of elongated members (1) works as a composed structural system (in a cooperative way) with the other components of said structural slab (6). Therefore, the structural slab (6) of the invention do not involve big manufacturing costs, is light, and has a good structural and isolating performance. The structural performance of the structural slab (6) of the invention is so good that when the related spans are short there is no need for auxiliary supporting elements oriented to avoid the downwards bending of the structural slab (6) caused by its own weight, during the concrete harden process; and when the related spans are bigger there is a need for a significantly fewer amount of auxiliary supporting elements. However, in the last case, it can be used a bigger number of said auxiliary supporting elements in order to have a structural performance even better for the structural slab (6) of the invention.

### DESCRIPTION OF THE PREFERRED EMBODIMENT OF THE INVENTION

In the preferred embodiment, the invention involves a particular configuration for the elongated member (1) and the structural slab (6) fabricated with a plurality of said elongated members (1), blocks of isolating material (7), a mesh (8) and a concrete element (9) working as a composed structural system in combination with the other elements of the structural slab (6).

The cross section of said elongated member (1), in the preferred embodiment, is hollow and opened on top and its outline is similar to an upside-down “T”, where each one of said walls of said first couple of walls of said cross section of said elongated member (1) comprises a first part essentially vertical, which connects one of said upper ends (2) with a first intermediate end arranged at the same height of said lower ends (3); and a first part essentially horizontal, which connects said first intermediate end with the corresponding lower end (3). Besides, each one of said walls of said second couple of walls comprises a second part essentially vertical, which connects one of said lower ends (3) with a second intermediate end located at the height of said joining point (4); and a second part essentially horizontal, that connects said second intermediate end with said joining point (4).

Additionally said cross section of said elongated member (1), in the preferred embodiment, comprises a third couple of walls, essentially symmetrical with respect to said symmetry vertical plane, each one being horizontal and connecting one of said upper ends (2), of said first couple of walls, with a final end (5) which is essentially at the same height than said upper end (2) and farther from said symmetry vertical plane than said upper end (2). Besides, each one of said walls of said third couple of walls comprises a reinforcement fold, which reinforces the cross section of said elongated member (1) in the zone of said third couple of walls where said final ends (5) are located.

The structural slab (6) of the invention, in the preferred embodiment, comprises a horizontal array of hollow elongated members (1), like the previously described, separated with respect to each other a distance essentially similar; a plurality of blocks of polystyrene (7), arranged between said elongated members (1) and supported partially on the above mentioned first parts essentially horizontal of said first couple of walls, where the upper part of said blocks of polystyrene (7) is arranged essentially lower than the upper part of said elongated members (1); a mesh (8) supported on the upper part of said horizontal array of elongated members (1); a concrete element (9) which fills essentially all the places between an horizontal plane located a little over said mesh (8) and the upper surfaces of said elongated members (1) and said blocks of polystyrene (7).

Said blocks of polystyrene (7) do not touch said first part essentially vertical of each one of said walls of said first couple of walls of said elongated members (1); reason for what said concrete element (9) fills each one of the places between said first part essentially vertical, the corresponding wall of said third couple of walls, the corresponding block of polystyrene (7), and the corresponding part of said first part essentially horizontal in which said block of isolating material is not supported (7); therefore the structure of said slab become reinforced.

Said concrete element (9) is fabricated starting from a predetermined amount of concrete which is poured over the other components of the structural slab (6) and allow the different components of said structural slab (6) to work as a composed structural system.

### DESCRIPTION OF THE DRAWINGS

FIG. 1 shows the cross section of the elongated member (1) of the preferred embodiment of the invention.

FIG. 2 shows the cross section of the structural slab (6) of the present invention, which comprises a horizontal array of the elongated members (1) of the invention, a plurality of blocks of isolating material (7), a mesh (8) and a concrete element (9) working as a composed structural system in combination with the other elements of the structural slab (6)

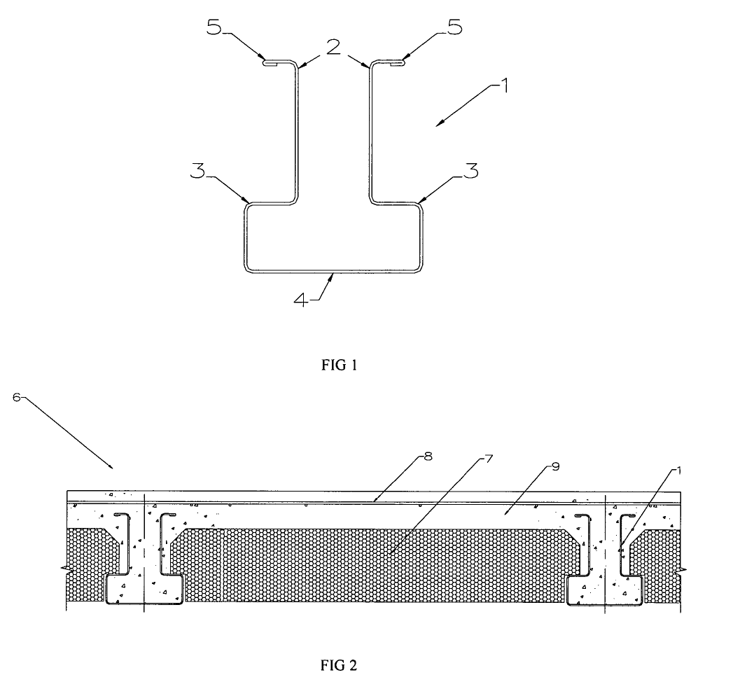

1. An elongated member (1) made of metal, or other suitable material, which cross section is hollow and open in the top and is essentially symmetrical with respect to a symmetry vertical plane, which has very convenient structural features, CHARACTERIZED in that said cross section comprises a first couple of walls, essentially symmetrical with respect to said symmetry vertical plane, each one connecting an upper end (2) with a lower end (3), where said lower end (3) is essentially lower than said upper end (2) and farther from said symmetry vertical plane than said upper end (2); and a second couple of walls, essentially symmetrical with respect to said symmetry vertical plane, each one connecting one of said lower ends (3), of said first couple of walls, with said symmetry vertical plane in a joining point (4), where are joined said walls of said second couple of walls; in such a way that said cross section of said elongated member (1) defines a cavity, opened on its top, which is significantly wider in at least one zone of its lower part with respect to its upper part.

2. An elongated member (1) according to claim 1, CHARACTERIZED in that said cross section comprises additionally a third couple of walls, essentially symmetrical with respect to said symmetry vertical plane, each one connecting one of said upper ends (2), of said first couple of walls, with a final end (5) which is essentially at the same height than said upper end (2) and farther from said symmetry vertical plane than said upper end (2).

3. An elongated member (1) according to claim 2, CHARACTERIZED in that each one of said walls of said third couple of walls comprises additionally a reinforcement fold, which reinforces the cross section of said elongated member (1) in the zone of said third couple of walls where said final ends (5) are located.

4. An elongated member (1) according to any of the preceding claims, CHARACTERIZED in that each one of said walls of said first couple of walls comprises a first part essentially vertical, which connects one of said upper ends (2) with a first intermediate end located at the height of said lower ends (3); and a first part essentially horizontal, which connects said first intermediate end with the corresponding lower end (3).

5. An elongated member (1) according to any of the preceding claims, CHARACTERIZED in that each one of said walls of said second couple of walls comprises a second part essentially vertical, which connects one of said lower ends (3) with a second intermediate end located at the height of said joining point (4); and a second part essentially horizontal, that connects said second intermediate end with said joining point (4).

6. An elongated member (1) according to any of the claims 2 to 5, CHARACTERIZED in that each one of said walls of said third couple of walls is essentially horizontal.

7. A structural slab (6) that comprises a horizontal array de beams, separated respect to each other a distance essentially similar, where the cross section of each one of said beams is essentially symmetrical with respect to a symmetry vertical plane; a plurality of blocks of isolating material (7), whose density is essentially smaller than concrete, arranged between said beams and supported by the side of the same, where the upper part of said blocks of isolating material (7) is arranged essentially lower than the upper part of said beams; a mesh (8) made of metal, or another suitable material, which is supported by the upper part of said horizontal array of beams; a concrete element (9); CHARACTERIZED in that each one of said beams includes a hollow elongated member (1) made of metal, or another suitable material, whose cross section is essentially symmetrical with respect to said symmetry vertical plane and opened on top; said blocks of isolating material (7) are supported by the sides of said elongated members (1); said concrete element (9) fills essentially all the places between an horizontal plane located a little over said mesh (8) and the upper surfaces of said elongated members (1) and said blocks of isolating material (7); and said cross section of said elongated member (1) comprises a first couple of walls, essentially symmetrical with respect to said symmetry vertical plane, each one connecting an upper end (2) with a lower end (3), where said lower end (3) is essentially lower than said upper end (2) and farther from said symmetry vertical plane than said upper end (2); and a second couple of walls, essentially symmetrical with respect to said symmetry vertical plane, each one connecting one of said lower ends (3), of said first couple of walls, with said symmetry vertical plane in a joining point (4) where are joined said walls of said second couple of walls; in such a way that said cross section of said elongated member (1) defines a cavity, opened on its top, which is significantly wider in at least one zone of its lower part with respect to its upper part.

8. A structural slab (6) according to claim 7, CHARACTERIZED in that said cross section comprises additionally a third couple of walls, essentially symmetrical with respect to said symmetry vertical plane, each one connecting one of said upper ends (2), of said first couple of walls, with a final end (5) which is essentially at the same height than said upper end (2) and farther from said symmetry vertical plane than said upper end (2).

9. A structural slab (6) according to claim 8, CHARACTERIZED in that each one of said walls of said third couple of walls comprises additionally a reinforcement fold, which reinforces the cross section of said elongated member (1) in the zone of said third couple of walls where said final ends (5) are located.

10. A structural slab (6) according to any of the claims 7 to 9, CHARACTERIZED in that each one of said walls of said first couple of walls comprises a first part essentially vertical, which connects one of said upper ends (2) with a first intermediate end located at the height of said lower ends (3); and a first part essentially horizontal, which connects said first intermediate end with the corresponding lower end (3).

11. A structural slab (6) according to any of the claims 7 to 10, CHARACTERIZED in that each one of said walls of said second couple of walls comprises a second part essentially vertical, which connects one of said lower ends (3) with a second intermediate end located at the height of said joining point (4); and a second part essentially horizontal, that connects said second intermediate end with said joining point (4).

12. A structural slab (6) according to any of the claims 8 to 11, CHARACTERIZED in that each one of said walls of said third couple of walls is essentially horizontal.

13. A structural slab (6) according to any of the claims 10 to 12, CHARACTERIZED in that said blocks of isolating material (7) are supported by said first part essentially horizontal of each one of said walls of said first couple of walls of said elongated members (1); and they do not touch said first part essentially vertical of each one of said walls of said first couple of walls of said elongated members (1); reason for what said concrete element (9) fills each one of the places between said first part essentially vertical, the corresponding wall of said third couple of walls, the corresponding block of isolating material (7), and the corresponding part of said first part essentially horizontal in which said block of isolating material is not supported (7); therefore the structure of said slab become reinforced.
